(19) United States
(12) Patent Application Publication
(10) Pub. No.: US 2013/0006782 A1
(43) Pub. Date: Jan. 3, 2013

(54) APPARATUS AND SYSTEMS OF A COMPUTERIZED BILL PRESENTER SYSTEM

(76) Inventors: Aron Schwarzkopf, Boston, MA (US); Sebastian Castro, Boston, MA (US)

(21) Appl. No.: 13/342,492

(22) Filed: Jan. 3, 2012

Related U.S. Application Data
(60) Provisional application No. 61/429,376, filed on Jan. 3, 2011.

(51) Int. Cl. G06Q 20/32; G06Q 20/20; G06Q 20/14; G06Q 20/34

(52) U.S. Cl. 705/17; 705/16; 705/21

(57) ABSTRACT

In some embodiments, an electronic check presenter includes a bi-fold booklet and a tablet personal computer. The tablet personal computer includes at least a non-transitory processor-readable medium, a processor, a display, a magnetic stripe reader, and a communication interface. The non-transitory processor-readable medium includes code to cause a processor to send a signal to display information on the display associated with a check and/or payment thereof.

### CROSS-REFERENCE TO RELATED APPLICATION

This application claims priority to and the benefit of U.S. Provisional Patent Application Ser. No. 61/429,376, filed Jan. 3, 2011, entitled “A Computerized Guest Check Presenter,” the disclosure of which is hereby incorporated by reference in its entirety.

### BACKGROUND

Embodiments described herein relate generally to presenting a bill to an entity and more particularly, presenting a bill to a patron using a computerized bill presenter.

The retail industry is highly competitive and often survival of a restaurant depends on providing customers with the utmost quality of service in an efficient and effective way. Systems that allow service and/or retail merchants to economize their costs, while improving their overall customer experience are paramount to maintaining a successful establishment. Ensuring that orders are placed correctly and that billing is handled precisely and conveniently is essential to promoting customer satisfaction and increase brand loyalty.

Some known businesses, however, struggle to execute efficient and effective methods for providing service. In some cases, verbal orders can be misunderstood, annotated incorrectly, or misinterpreted by the staff. Paper bills run the risk of being miscalculated or misprinted, present challenges for customers wishing to split the bill among multiple parties, as well as collect feedback.

In some instances, a computerized guest check presenter is utilized to try to facilitate these processes, such as Restaurant Management Software, point of sale (POS) transaction systems, and tablets. In some instances, a tablet can be configured to provide a user with a familiar appearance, such as, for example, a known billfold. Often these systems are fragmented and complex, requiring servers to interact with a wide assortment of paper-based and computer-based interfaces. Additionally, such known systems do not integrate with social networking such as, for example, Facebook ®, Twitter ®, Yelp ®, or Google+ ®.

Thus, a need exists for improved systems and methods for computerized bill presenting.

### SUMMARY

Apparatus and systems of a computerized bill presenter system are described herein. In some embodiments, a computerized bill presenter includes a bi-fold booklet and a tablet personal computer. The tablet personal computer includes at least a non-transitory processor-readable medium, a processor, a display, a magnetic strip reader, and a communication interface. The non-transitory processor-readable medium includes code to cause a processor to send a signal to display information on the display associated with a check and/or payment thereof.

### BRIEF DESCRIPTION OF THE DRAWINGS

FIG. 1 is a schematic illustration of a computerized bill presenter in communication with a network, according to an embodiment.

FIG. 2 is a schematic illustration of a processor included in the computerized bill presenter of FIG. 1.

FIG. 3 is a perspective view of a computerized bill presenter, according to an embodiment.

FIG. 4 is a perspective view of the computerized bill presenter of FIG. 3, in a second configuration.

FIG. 5 is an exploded view of the computerized bill presenter of FIG. 3.

FIG. 6 is a perspective view of a circuit board included in the computerized bill presenter of FIG. 3.

FIGS. 7-25 are screenshots from a computerized bill presenter system in various configurations, according to an embodiment.

FIG. 26 is a perspective view of a charging dock, according to an embodiment.

FIG. 27 is an exploded view of the charging dock of FIG. 26.

FIG. 28 is a perspective view of a charging station, according to an embodiment.

FIG. 29 is an exploded view of the charging station of FIG. 28.

### DETAILED DESCRIPTION

Apparatus and systems of a computerized bill presenter system are described herein. In some embodiments, a computerized bill presenter (also referred to herein as computerized check presenter or electronic check presenter) includes a bi-fold booklet and a tablet personal computer. The tablet personal computer (PC) includes at least a non-transitory processor-readable medium, a processor, a display, a magnetic stripe reader, and a communication interface. The non-transitory processor-readable medium includes code to cause a processor to send a signal to display information on the display associated with a check and/or payment thereof.

As used in this specification, the singular forms “a,” “an” and “the” include plural referents unless the context clearly dictates otherwise. Thus, for example, the term “a network” is intended to mean a single network or a combination of networks.

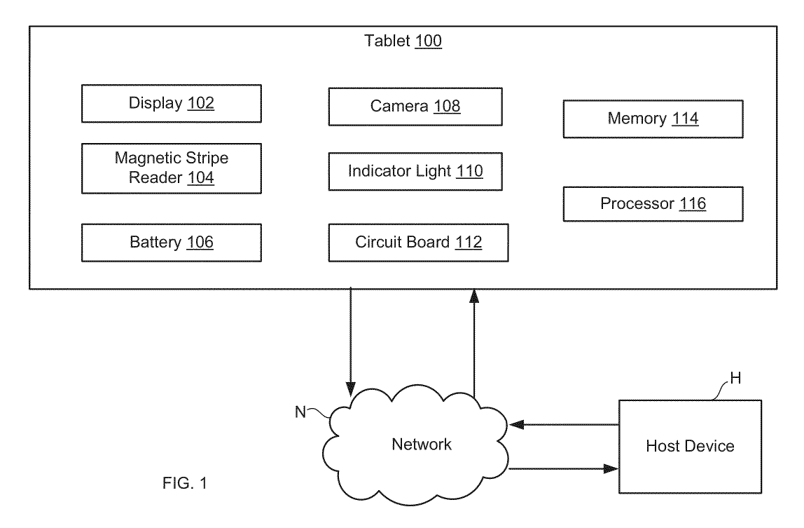

FIG. 1 is a schematic illustration of a system that includes an electronic device in communication with a network, according to an embodiment. An electronic device can be, for example, a tablet, a personal digital assistant (PDA), a smart phone, and/or the like. A network can be any type of network (e.g., a local area network or LAN, a wide area network or WAN, a virtual network, a telecommunications network, and/or the internet) implemented as a wired network and/or a wireless network. As described in further detail herein, in some embodiments, for example as shown in FIG. 1, the electronic device is a tablet 100 in communication with a host device H (e.g., a personal computer, a server, a work station, a tablet, and/or the like) via a network N (e.g. a LAN and/or an Internet Service Provider (ISP) and the Internet).

The tablet 100 can be configured to include a display 102, a magnetic strip reader 104, a battery 106, a camera 108, an indicator light 110, a circuit board 112, a memory 114, and a processor 116. While not shown in FIG. 1, in some embodiments, the tablet 100 can include one or more network interface devices (e.g., a network interface card) configured to connect the tablet 100 to the network N.

The display 102 can be any suitable display configured to provide a user interface to the tablet 100. For example, the display 102 can be a liquid crystal display (LCD) monitor, a light emitting diode (LED) monitor, and/or the like. The display 102 can be configured to provide the user interface for a tablet application, mobile application, internet web browser, and/or the like. In such embodiments, the display 102 can be configured to graphically represent a computerized bill presenting system. The display 102 can further be configured to include a touch screen (e.g., a resistive touch screen, a capacitive touch screen, and/or the like). In this manner, a user can engage the touch screen with a finger to interact with graphically displayed images on the display 102. In some embodiments, the user can utilize a stylus to engage the touch screen.

The magnetic strip reader 104 can be any suitable reader configured to read a magnetic strip (e.g., as included in a credit card, a debit card, and/or the like). In some embodiments, the magnetic strip reader 104 can be coupled to the circuit board 112 and be configured to pass a signal to, for example, the processor 116, via any suitable connection such as Universal Serial Bus (USB), Peripheral Component Interconnect (PCI), FireWire, Thunderbolt, and/or the like. In some embodiments, the magnetic strip reader 104 can be integrally formed with the tablet 100 and/or the circuit board 112. In this manner, a user can swipe, for example, a debit card, through the magnetic strip reader 104 such that a signal is sent representing payment of at least a portion of a check.

The battery 106 can be any suitable battery configured to provide power to the tablet 100. For example, in some embodiments, the battery 106 can be a lithium-ion battery. In this manner, the battery 106 can supply power to the tablet 100 and can be recharged using, for example, a charging dock, a charging station, a power cable, and/or the like, as described in further detail herein.

The camera 108 can be any suitable camera configured to take a picture and/or video. For example, in some embodiments, the camera 108 can be used to take a picture of a person, a user, a food item, etc. In some embodiments, the camera 108 can be used to take a picture and send a signal representing the picture to be stored in the memory 114 and/or a cloud server. Furthermore, the tablet 100 can be configured to post and/or share, via the network N, a picture taken by the camera 108 on a social networking site such as, for example, Facebook ®.

The indicator light 110 can be any suitable light source configured to display a color, a flash pattern, and/or the like, thereby indicating a current state of the tablet 100. For example, in some embodiments, the indicator light 110 is a light emitting diode (LED). In some embodiments, the indicator light 110 can be configured to display, for example, a green color when the magnetic strip reader 104 successfully receives information stored in the magnetic strip of a debit card. In some embodiments, the indicator light 110 can be configured to display, for example, a red color when the magnetic strip reader 104 does not successfully receive information stored in the magnetic strip of the debit card. In some embodiments, the indicator light 112 can be configured to flash and/or otherwise display a color or pattern to indicate a low power state of the tablet 100 (or other user interaction and states).

The circuit board 112 can be any suitable circuit board. For example, in some embodiments, the circuit board 112 can be a printed circuit board (PCB). The circuit board 112 can be configured to interact with the components (e.g., described above) of the tablet 100. For example, in some embodiments, the circuit board 112 can be configured to send a signal from the magnetic strip reader 104 to the processor 116 to be processed. The circuit board 112 can include any suitable ports, connections, and/or sockets configured to receive, for example, the memory 114, the processor 116, the magnetic strip reader 104, and/or the like.

The memory 114 can be, for example, a random access memory (RAM), a memory buffer, a hard drive, a read-only memory (ROM), an erasable programmable read-only memory (EPROM), and/or so forth. In some embodiments, the memory 114 of the tablet 100 stores instructions to cause the processor 116 to execute modules, processes, and/or functions associated with using a tablet application, mobile application, an internet web browser, and/or the like. Furthermore, the memory 114 stores instructions to cause the processor 116 to send signal information to or receive signal information from the display 102, the magnetic strip reader 104, the camera 108, and/or the indicator light 110. For example, in some embodiments, the tablet 100 receives a user input for a food order (e.g., the user engages the touch screen to interact with a graphically displayed image representing a menu). In such embodiments, the memory 114 is configured to store the order such that the host device H can access data associated with the order, via the network N. Additionally, the memory 114 can be configured to associate the order with cost information stored in the memory 114. In this manner, the processor 116 can access the order and cost information, stored in the memory 114, and send a signal to the display 102 representing a check including the cost of selected menu items and a total cost of all the selected menu items, as described in further detail herein. In some embodiments, the memory 114 can receive and store user profiles, such as, for example, a patron profile and/or an employee profile (e.g., a waitperson).

The processor 116 of the tablet 100 can be any suitable processing device configured to run and/or execute a set of instructions or code. For example, the processor 116 can be a general purpose processor, a central processing unit (CPU), an accelerated processing unit (APU), and/or the like. As described above, the processor 116 can be configured to run and/or execute a set of instructions or code stored in the memory 114 associated with using a tablet application, mobile application, an internet web browser, and/or the like. For example, in some embodiments, the processor 116 can run and/or execute a set of instructions associated with a system for receiving a food and/or merchandise order and sending a signal to the display 102 representing a check, as described in further detail herein.

In some embodiments, the tablet 100 can communicate with the host device H (also referred to herein as “host H”) and the network N via intermediate networks and/or alternate networks. Such intermediate networks and/or alternate networks can be of a same type and/or a different type of network as network N. As such, in some embodiments, the tablet 100 can send data to and/or receive data from the host H using multiple communication modes (e.g., email, instant messages, barcode transmissions, using a mobile device application, via a website, using a personal computer (PC) application, etc.) that may or may not be transmitted to the host H using a common network. For example, the tablet 100 can be connected to the host H via a cellular network and the Internet (e.g., network N).

The host H can be any type of device configured to send data over the network N to, and/or receive data from, one or more tablets 100. In some embodiments, the host H can be configured to function as, for example, a server device (e.g., a web server device), a network management device, and/or so forth. In some embodiments, the host H includes at least a processor and a memory (not shown).

The memory included in the host H can be, for example, a random access memory (RAM), a memory buffer, a hard drive, a read-only memory (ROM), an erasable programmable read-only memory (EPROM), and/or so forth. The processor can be any suitable processor such as, for example, a general purpose processor, a central processing unit (CPU), a network processor, a front end processor, and/or the like. In some embodiments, the memory of the host H includes a set of instructions used to receive a restaurant patron's order from the tablet 100 via the network N. In such embodiments, the patron can place a food and/or merchandise order via the tablet 100 and the host H can receive the order such that the processor of the host H can send a signal representing the order to a display to be viewed by a chef and/or kitchen staff member.

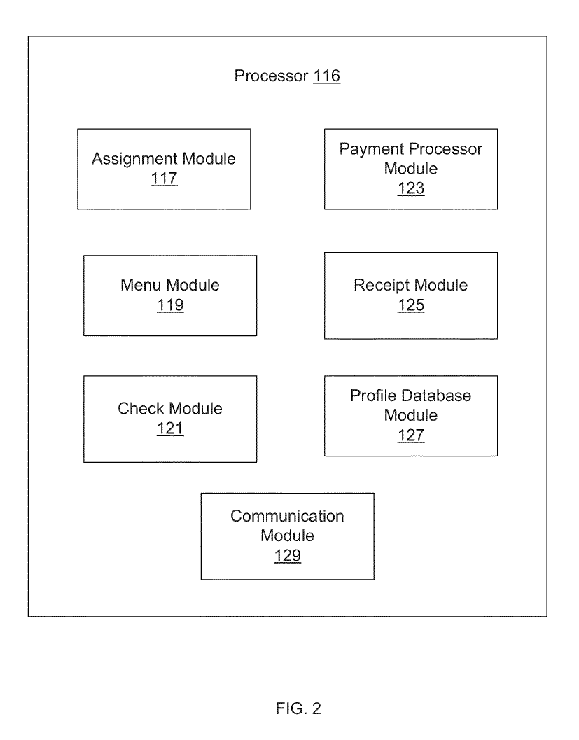

The processor 116, as shown in FIG. 2, can be configured to execute specific modules. The modules can be, for example, hardware modules, software modules stored in the memory 114 (FIG. 1) and executed in the processor 116, and/or any combination thereof. The modules can include an assignment module 117, a menu module 119, check module 121, a payment processor module 123, a receipt module 125, a profile database module 127, and a communication module 129.

The assignment module 117 can include instructions, executed by the processor 116, associated with assigning open tables and/or tabs to a patron or party. The assignment module 117 can be configured to store, in the memory 114, information associated with seating arrangements of the restaurant. For example, in such embodiments, the memory 114 can store information associated with open tables and/or tabs, occupied tables, reservations, and/or the like. Furthermore, the assignment module 117 can be configured to access, edit, rewrite, and/or remove information stored in the memory 114 associated with assigning patrons and/or parties to a table. In some embodiments, the host H can store, in memory, the information associated with the seating arrangements of the restaurant. In such embodiments, the assignment module 117 can include instructions, executed by the processor 116, to send a signal, via the network N, to the host device H to access, edit, rewrite, and/or remove information associated with assigning patrons and/or parties to a table.

In some embodiments, the processor 116 can send a signal to the display 102 such that the display 102 shows a graphical representation of the information associated with the seating arrangements. In such embodiments, the display 102 can present questions and/or drop down menus associated with the number of guests in a party. In this manner, the assignment module 117 can include instructions, executed by the processor 116, to access, change, update, or otherwise interact with information stored in the memory 114 and/or shown on the display 102 associated with assigning a patron or party a table, as described in further detail herein.

The menu module 119 can include instructions, executed by the processor 116, associated with displaying a menu and/or receiving a menu selection. In some embodiments, the menu module 119 can include instructions, executed by the processor 116, to access a menu stored in the memory 114 and to send a signal representing the menu to the display 102. In this manner, the display 102 can provide a graphical representation of the menu. In some embodiments, the menu module 119 can receive a user input (e.g., a typed input, a selection from a drop down menu, or an engagement of a portion of the display 102 representing a button or trigger) of a menu selection and include instructions, executed by the processor 116, to send a signal representing the menu selection to the host device H, via the network N.

The check module 121 can include instructions, executed by the processor 116, to generate a check based on a set of menu selections. As described above, in some embodiments, the memory 114 can store information associated with a set of costs. In such embodiments, the check module 121 can include instructions, executed by the processor 116, to access the cost information stored in the memory 114 and associate the cost information with a given menu selection. For example, the check module 121 can include instructions, executed by the processor 116, to receive a menu selection and based on the menu selection, retrieve the cost of the menu selection from the memory 114. In some embodiments, the set of costs of the set of menu items can be stored in the memory of the host device H. In such embodiments, the check module 121 can include instructions, executed by the processor 116, to access the cost information stored in the memory of the host device H, via the network N. The check module 121 can further include instructions, executed by the processor 116, to send a signal representing the check information to be graphically displayed on the display 102.

The payment processor module 123 can include instructions, executed by the processor 116, to receive and/or send a signal representing payment information. For example, the payment processor module 123 can receive a signal from the magnetic strip reader 104 associated with a debit card payment of a check. In some embodiments, the payment processor module 123 can include instructions, executed by the processor 116, to send a signal, via the network N, to verify and/or process the payment (e.g., send a signal to a bank associated with the payment information). In some embodiments, the payment processor module 123 can include instructions, executed by the processor 116, to receive payment information via near field communication (NFC). In some embodiments, the payment processor module 123 can include instructions, executed by the processor 116, to receive payment information via an application configured to take a picture of a credit card or debit card.

The receipt module 125 can include instructions, executed by the processor 116, associated with providing a receipt to a patron or patrons. For example, in some embodiments, a patron can place a menu selection and the check module 121 can prepare a check based on the menu selection. When the patron pays for the check, the payment processor module 123 can send a signal to the receipt module 125. In this manner, the receipt module 125 can include instructions, executed by the processor 116, to, for example, send an electronic mail (email) of the receipt to the patron's email address, send an electronic receipt to a mobile device application and/or the like, to send a signal to a printer such that the printer prints the receipt, or to discard the receipt information (e.g., delete from the memory 114).

The profile database module 127 can include instructions, executed by the processor 116, associated with creating and storing a profile database in the memory 114. For example, in some embodiments, the memory 114 can store a profile of a waitperson including information such as, for example, a greeting, a picture, a name, a rating, a tip, and/or the like. In such embodiments, a patron can access the profile of the waitperson and, for example, rate and/or tip the waitperson. The profile database module 127 can receive a signal representing the rating and include instructions, executed by the processor 116, to update the profile stored in the memory 114. In some embodiments, the profile database module 127 can be configured to store a patron's profile. In such embodiments, the profile can include information associated with, for example, discounts, coupons, favorite server, last date of visit, and/or the like. Additionally, the profile database module 127 can include instructions, executed by the processor 116, to associate the patron's profile with a profile on a social networking site such as, for example, Facebook ®, Twitter ®, Google+ ®, Yelp ®, and/or the like. In some embodiments, the profile database can be stored in the memory of the host device H. In such embodiments, the profile database module 127 can include instructions, executed by the processor 116, to access the profile database via the network N.

The communication module 129 includes a set of instructions, executed by the processor 116, associated with communicating with the network N. For example, the communication module 129 can include instructions, executed by the processor 116, to communicate with the internet, a LAN, a WAN, and/or the like. As described above, in some embodiments, the communication module 129 can include a set of instructions, executed by the processor 116, to send an email including a receipt to a patron's email address. In some embodiments, the communication module 129 can be configured to send a signal representing access to a social networking site. For example, the communication module 129 can be configured to allow a patron to post a picture and/or “check-in” on Facebook ®, post a tweet on Twitter ®, and/or rate the restaurant on Yelp ®.

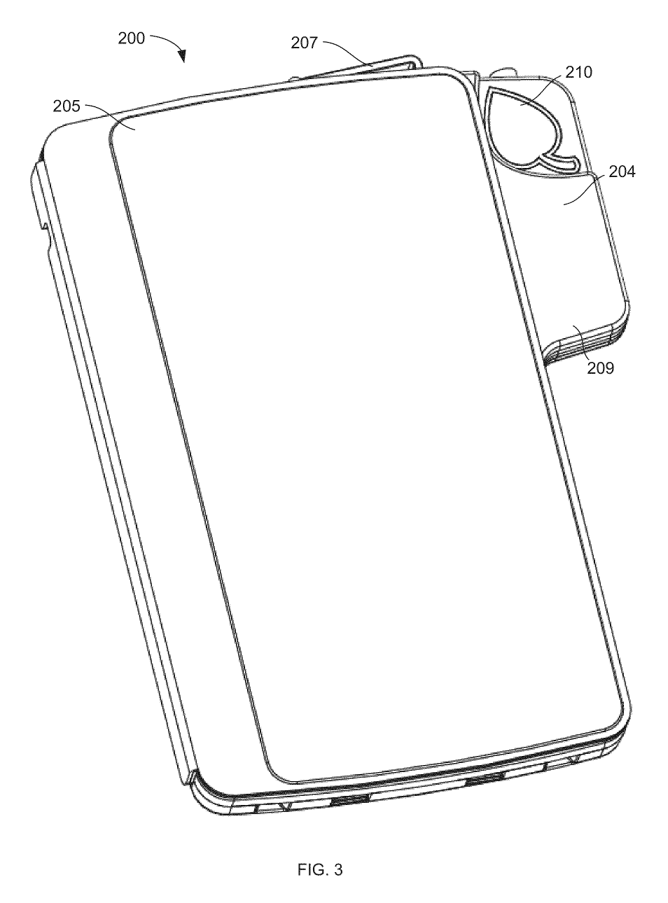

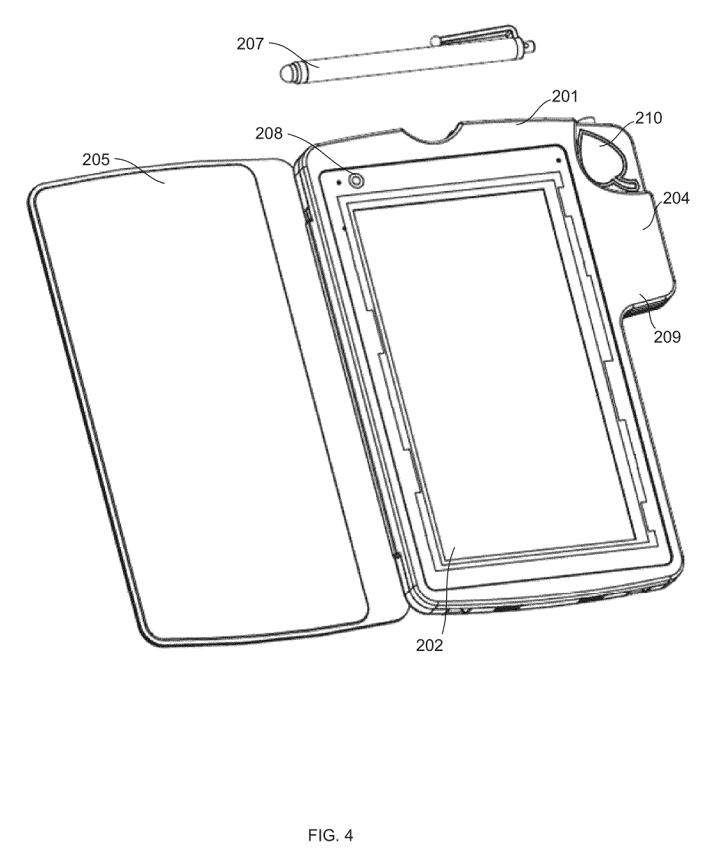

FIGS. 3-6 illustrate an electronic check presenter, according to an embodiment. The electronic check presenter includes, for example, a Wi-Fi enabled tablet PC 200 (also referred to herein as “tablet 200”), a stylus 207, and a bi-fold booklet 205. The stylus 207 can be any suitable known stylus 207 configured to engage a touch screen of a tablet PC. The bi-fold booklet 205 can be configured to move between a first configuration (FIG. 3) and a second configuration (FIG. 4) and is configured to house at least a portion of the tablet 200.

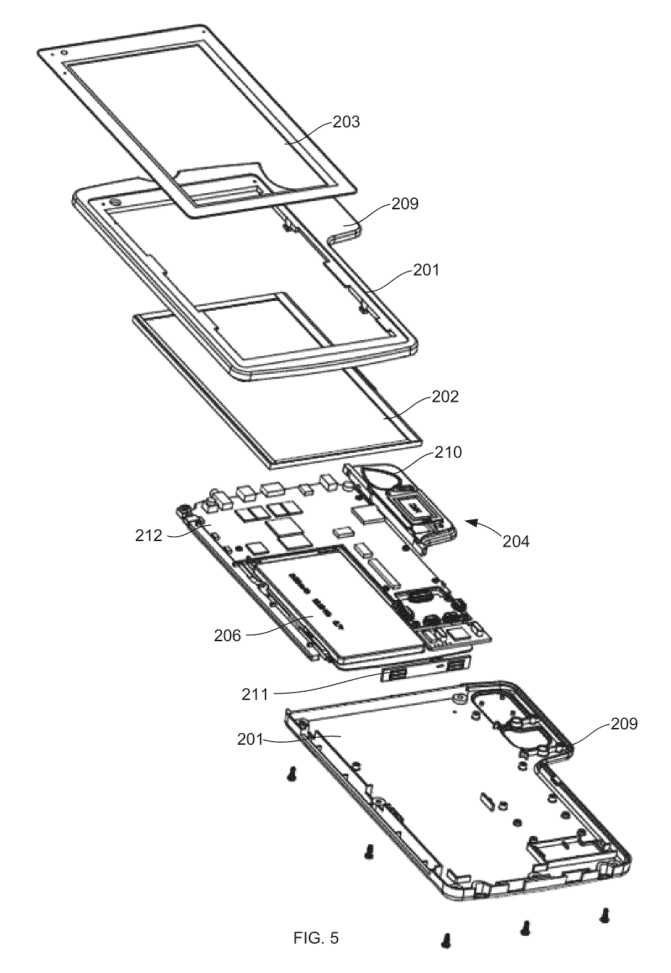

The bi-fold booklet 205 can be pivotally coupled to the tablet 200. For example, the bi-fold booklet 205 can pivot about a hinged portion configured to be coupled to a housing 201 (FIG. 5) of the tablet 200. The bi-fold booklet 205 can be formed from a leather, a fabric, a plastic, a vinyl, and/or the like and can be any suitable size or shape. In some embodiments, the bi-fold booklet 205 can be configured to substantially resemble a known check presenter such as to be familiar in shape to the user (e.g., a patron and/or a waitperson). Furthermore, the bi-fold booklet 205 can be configured to include a pocket (not shown) on an interior surface. The pocket can receive, for example, cash, coins, and/or credit/debit cards.

Referring to FIG. 5, the tablet 200 can include a housing 201, a circuit board 212, a magnetic strip reader 204, an indicator light 210, a display 202, and a touch screen 211. In some embodiments, the tablet 200 can be similar, at least partially, in form and function to known tablets. In this manner, aspects of the tablet 200 are not described in detail herein. Furthermore, it should be known that the embodiments described herein are presented by way of example and not limitation. Thus, the tablet 200 can include any suitable known features available that are not explicitly described herein. For example, the tablet 200 can include any suitable input device such as a keyboard, a mouse, the stylus 207, a microphone, the touch screen 211, and/or any suitable reader or scanner. In addition, the tablet 200 can include any suitable output device such as, for example, the display 202, a speaker, a printer, the indicator light 210, and/or the like.

The tablet 200 can be configured to communicate over a network, as described above with respect to FIG. 1. For example, in some embodiments, the tablet 200 can communicate with a network via a wired connection and/or a wireless connection, such as, for example, Wi-Fi, Bluetooth, a cellular network, and/or the like. Furthermore, the tablet 200 can be configured to communicate with and/or act as a Wireless Access Point.

The housing 201 can be any suitable shape size or configuration. For example, the housing 201 can be substantially rectangular and include a protrusion 203. The housing 201 can be configured to house the circuit board 212 and the magnetic strip reader 212, as shown in FIG. 5.

The display 202 can be any suitable display, such as for example, those described above with respect to FIG. 1. Additionally, the display 202 can be operably coupled to a touch screen 203. The touch screen 203 can be a resistive touch screen, a capacitive touch screen, and/or any other suitable touch screen. In some embodiments, the touch screen 203 can be configured to be suitable for a restaurant environment (e.g., water resistant, scratch resistant, crack resistant, and/or the like). In this manner, a user of the tablet 200 can engage the touch screen 203 to interact with the tablet 200, as described herein.

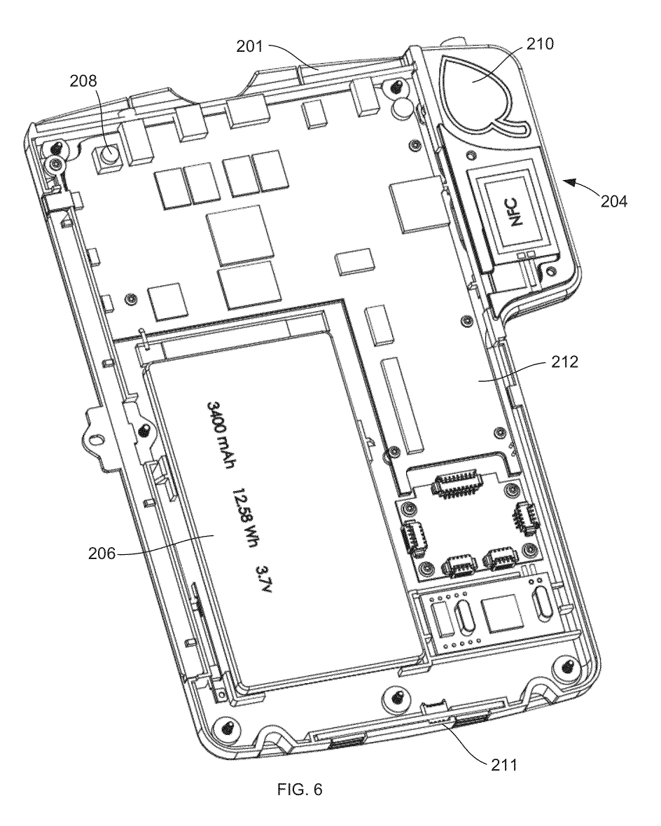

The circuit board 212 can be coupled to a bottom portion of the housing 201, as shown in FIG. 6. The circuit board 212 can include at least a memory (not shown) and a processor (not shown) and be configured to function similarly to known computing electronic devices (e.g., the circuit board 212 can include any known feature operative to the functioning of an electronic computing device). Furthermore, the circuit board 212 can be operably coupled to peripheral components. Similarly stated, the memory included in the circuit board 212 can include instructions, executed by the processor of the circuit board 212, to send and/or receive signals from the peripheral components. For example, as shown in FIG. 6, the circuit board 212 can be operably coupled to a battery 206, a charge portion 211, a camera 208, the magnetic strip reader 204, and the indicator light 210.

The battery 206 can be any suitable battery, such as, for example, those described with respect to FIG. 1. Furthermore, the charge portion 211 can be configured to deliver a flow of current from a charge source (not shown in FIGS. 3-6) to the battery 206, thereby charging the battery 206. The charge portion 211 can be any suitable configuration. For example, in some embodiments, the charge portion 211 can include conductive conducts configured to engage conducting contacts of the charge source. In some embodiments, the charge portion 211 can define a USB port or a plug. In some embodiments, the charge portion 211 can be configured to receive a flow of current via induction (e.g., the use of an electromagnetic field to transfer a current between two electrical conductors).

The indicator light 210 can be any suitable light source configured to display a color, a flash pattern, and/or the like, thereby indicating a current state of the tablet 200. In some embodiments, the indicator light 210 can be a light emitting diode (LED) configured to illuminate a light display. For example, as shown in FIGS. 3-6, the light display can be in the shape of a leaf and be illuminated by at least one LED (not shown) included in the tablet 200.

In some embodiments, the indicator light 210 can be configured to display, for example, a flashing light pattern to indicate the tablet 200 is ready to receive payment information. For example, in some embodiments, the indicator light 210 can flash a light pattern to indicate that the magnetic strip reader 204 is ready to receive a credit card, debit card, gift card, or the like. In other embodiments, the indicator light 210 can flash a light pattern to indicate to a user to place a near field communication (NFC) enabled device in range of a NFC component (e.g., transmitter/receiver) included in the tablet 200. In other embodiments, the indicator light 210 can flash a light pattern to indicate to a user to take a picture of a credit or debit card. In such embodiments, the indicator light 210 can be configured to flash the same light pattern for each payment method. In other embodiments, the indicator light 210 can flash a unique light pattern associated with a unique payment method (e.g., utilizing the magnetic strip reader 204, the camera 208, or a NFC interaction). In still other embodiments, the indicator light 210 can illuminate the light display with a solid color (e.g., not flashing) to indicate the tablet 210 is ready to receive payment information.

In some embodiments, the indicator light 210 can be configured to display a solid green color (e.g., not flashing) when the magnetic strip reader 204 successfully receives information stored in the magnetic strip of, for example, a debit card. Furthermore, the indicator light 210 can be configured to flash (any suitable number of times) to indicate the payment has been processed (e.g., accepted). In some embodiments, the indicator light 210 can be configured to display (solid or flashing) a red color when the magnetic strip reader 204 does not process (e.g., rejects) information stored in the magnetic strip of the debit card.

In some embodiments, the indicator light 210 can be configured to flash and/or otherwise display a color or pattern to indicate a low power state of the tablet 200. For example, in some embodiments, the indicator light 210 can be configured to display a flashing red light to indicate the low power state of the tablet 200. In other embodiments, the indicator light 210 can be configured to illuminate only a portion of the light display in relation to the power state of the tablet 200 (e.g., a larger portion of the light display illuminated corresponds to a larger amount of power available and a smaller portion of the light display illuminated corresponds to a smaller amount of power available).

The camera 208, the magnetic strip reader 204, and the indicator light 210 can be any suitable configuration, such as for example, those described with respect to FIG. 1. In this manner, certain aspects of the camera 208, the magnetic strip reader 204, and the indicator light 210 are not described in further detail. In addition, the function and interaction of the camera 208, the magnetic strip reader 204, the indicator light 210, and/or any other peripheral component with the memory and/or processor included in the circuit board 212 can be substantially similar to known devices and therefore, not described herein.

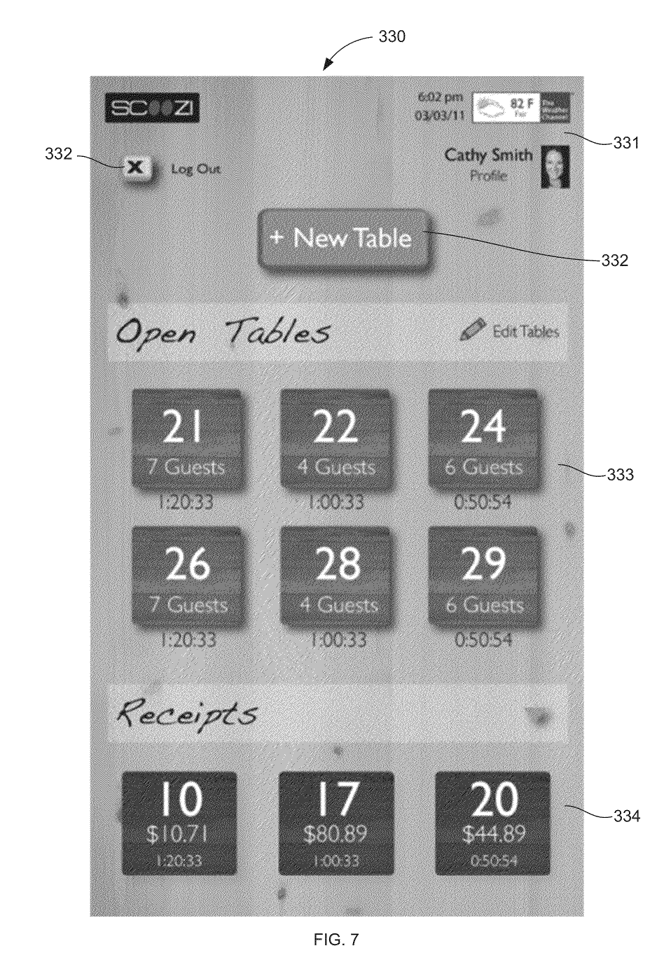

FIGS. 7-26 illustrate screenshots from an electronic check presenter system according to an embodiment. The electronic check presenter system can be any suitable system configured to receive an order from a restaurant and/or retail patron or patrons and display a check associated with the order. For example, the electronic check presenter system can include a tablet PC, such as those described herein. The tablet (not shown in FIGS. 7-26) can include at least a memory and a processor. The memory can include instructions, executed by the processor, to display a given user interface on the display of the tablet. As used herein, a user interface relates to a graphical representation of a set of instructions stored in memory and executed by the processor. Similarly stated, the user interface is an output on the display of the tablet that can be engaged by the user (e.g., visually and/or interactively via a touch screen). Therefore, the processor can send a signal to display various interfaces such that a user's interaction with the interfaces sends a signal to the processor to perform a given task (e.g., place an order, display a check, receive a payment, email a receipt, and/or the like).

Referring now to FIG. 7, a screenshot illustrates a reservation interface 330 in a first configuration. As described above, the processor can execute instructions, stored in the memory, to send a signal to the display such that the reservation interface 330 is displayed. The reservation interface 330 includes a header 331, an open tables and/or tabs field 333, and a receipt field 334. The reservation interface 330 can further include buttons 332 configured to be engaged by a user. More specifically, the buttons 332 are graphical representations of a set of instructions stored in memory to perform a given task, as commonly known by those skilled in the art.

The header 331 included in the reservation interface 330 can be any suitable shape, size, or configuration. In this manner, the header 331 is configured to define a portion of the reservation interface 330. In some embodiments, the header 331 can include a set of information, such as, for example, time, date, temperature, and/or login information. For example, as shown in FIG. 7, the header 331 includes the time, the date, the temperature, and the user name and profile picture of the user logged into the reservation interface 330. Additionally, the header 331 can include the “Log Out” button 332 operative to logging a user out of the reservation interface 330.

The open tables field 333 can include graphics representative of open tables and/or tabs. As shown in FIG. 7, the graphics can represent specific table numbers such as, for example, “21”, “22”, “28”, etc. In addition, the graphics can represent specific names related to a tab such as, for example, “Joe”, “Jessica”, “Scott”, etc. The graphics can also include information associated with the number of patrons the specific table can accommodate. For example, the table “21” can accommodate 7 guests. The graphics can be arranged in any suitable manner within the open table field 333 and can include any suitable information associated with a specific table.

The receipt field 334 can include graphics representative of receipt totals for a given table and/or tab. For example, the table “10” is shown with a receipt totaling “$10.71”. The receipt field 334 can provide a user (e.g., a waitperson) with information pertaining to the tables they are servicing. In some embodiments, a manager can use the information displayed in the receipt field 334 to rebalance a work load between any number of waitpersons.

The reservation interface 330 includes a button 332 operative to associating a table and/or tab with a specific patron or party. For example, the button 332 can be labeled “+ New Table”, or “+ New Tab” etc. While shown in a specific portion of the reservation interface 330, the “+ New Table” button 332 can be disposed at any suitable portion of the reservation interface 330. Furthermore, when engaged by a user, the “+ New Table” button 332 is configured to send a signal operative to displaying the reservation interface 330 in a second configuration.

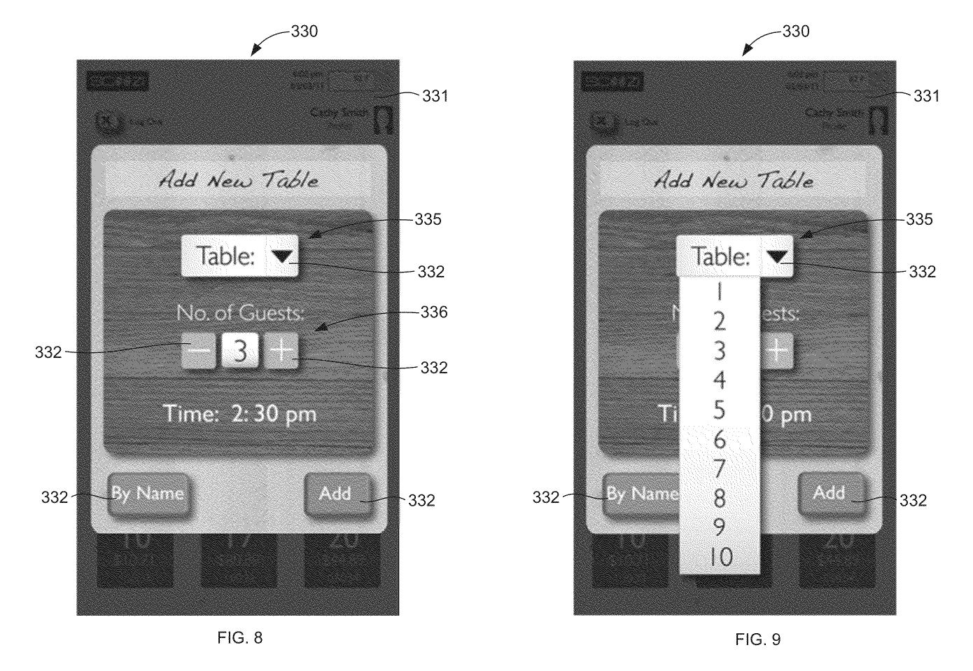

FIG. 8 illustrates the reservation interface 330 in the second configuration. For example, the reservation interface 330 is configured to display a table assignment field 335 and a guest field 336. The table assignment field 335 can include a button 332 operative to displaying a drop down menu representing a set of table numbers, as shown in FIG. 9. In this manner, the user can engage the drop down menu (e.g., touch the touch screen at the portion displaying the specific table number to be assigned) to select a given table. The guest field 336 also includes buttons 332 configured to increase or decrease the number shown on the display associated with the number of guests in the party. For example, the guest field 336, shown in FIG. 8, indicates a party of three. Furthermore, the guest field 336 can include time information associated with when a table is assigned to a guest or party.

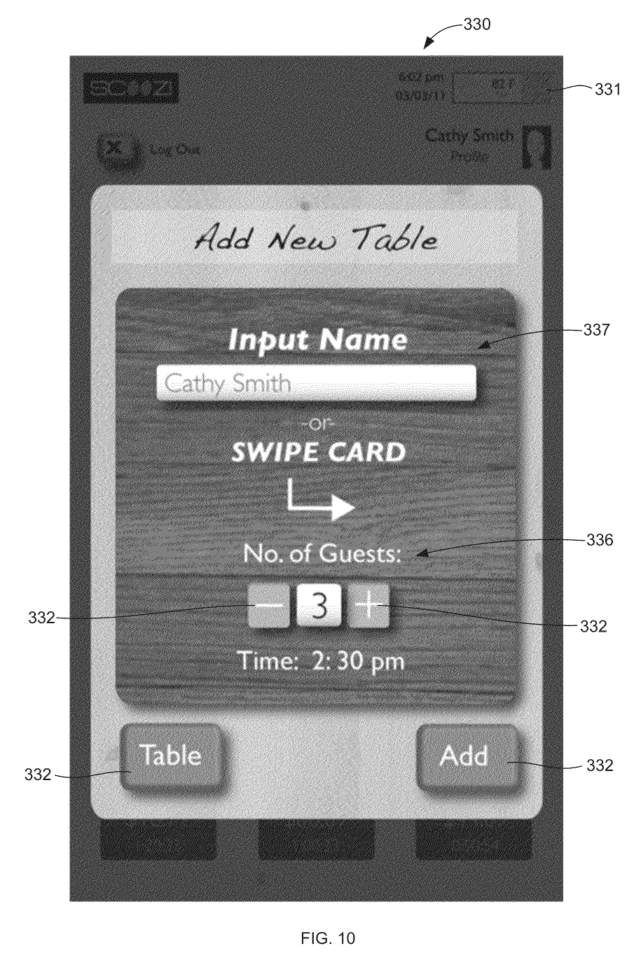

The reservation interface 330 can further include a button 332 labeled “Add”. The user can select the button 332 labeled “Add” to add (e.g., reserve) the selected table number to the guest or party. Additionally, the reservation interface 330 can include a button 332 labeled “By Name”. The button 332 labeled “By Name” can be operative to displaying the reservation interface 330 in a third configuration, as shown in FIG. 10.

In the third configuration, the reservation interface 330 can be configured to establish a reservation for and/or associate a table with a given patron. For example, in some embodiments, the patron may be a frequent diner. In such embodiments, the patron can establish a user profile to be stored in, for example, the user profile database, as described above. In such embodiments, the user can input their name in an input field 337 included in the reservation interface 330. In this manner, the electronic check presenter system can associate the user input with a specific user profile and access information associated with the user profile. For example, in some embodiments, a user associated with a user profile can receive discounts based on frequency of dinning at the restaurant and/or total money spent at the restaurant. In some embodiments, the user profile stored in the user profile database can be associated with a user profile on, for example, Facebook ®, Twitter ®, Yelp ®, Google+ ®, Foursquare ®, and/or the like. In this manner, the electronic check presenter can be configured to link the user profile stored in the user profile database with the user profile of a social networking site.

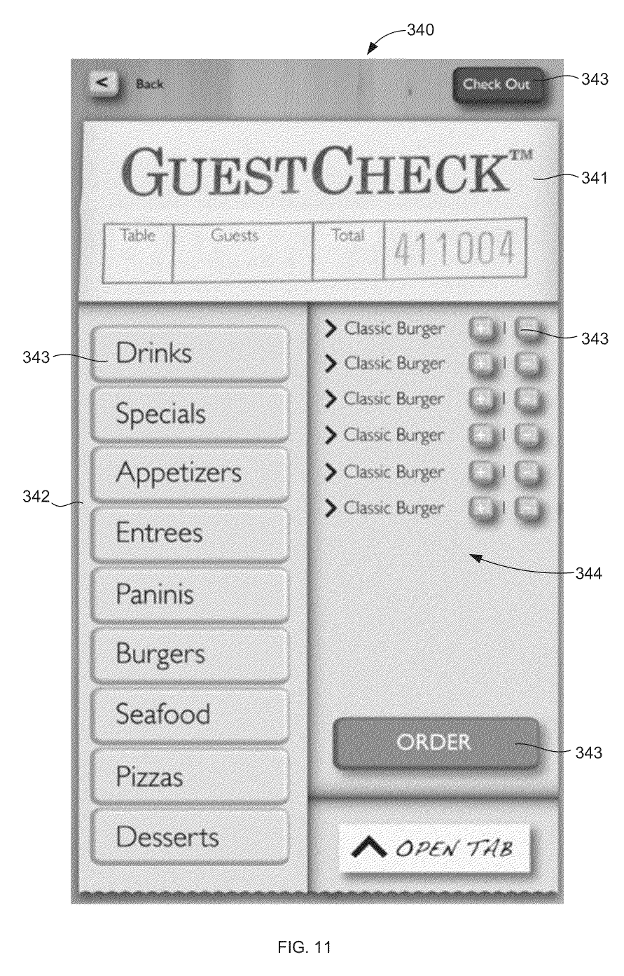

FIG. 11 illustrates a check interface 340 including a header 341, a menu category field 342, and an items ordered field 344. The header 341 is configured to resemble a header of known check books often used in restaurants. In this manner, the check interface 340 is configured to provide a familiar user interface for a waitperson and/or patron. The check interface 340 can further include buttons 343 operative to a specific action, as described in further detail herein.

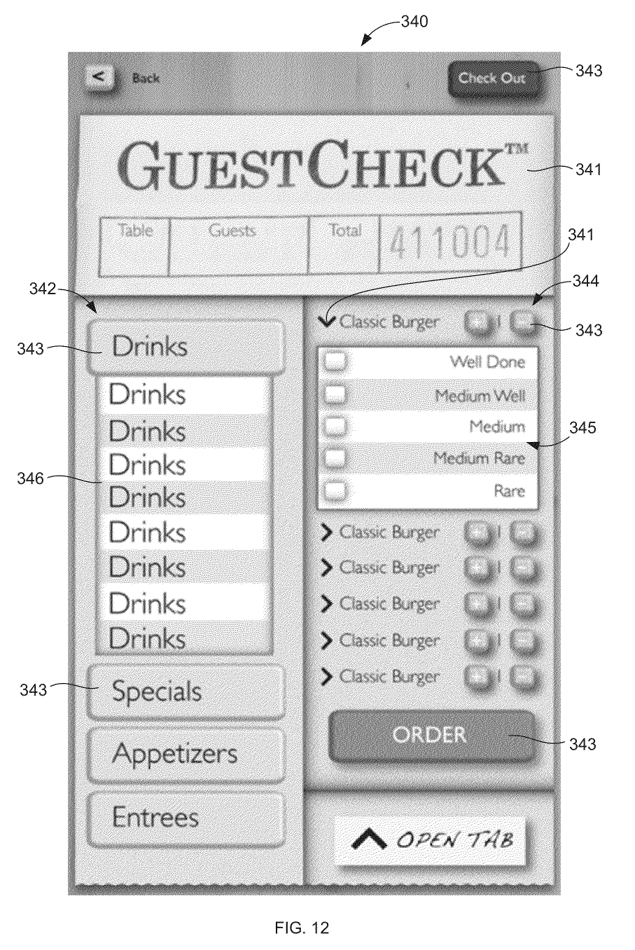

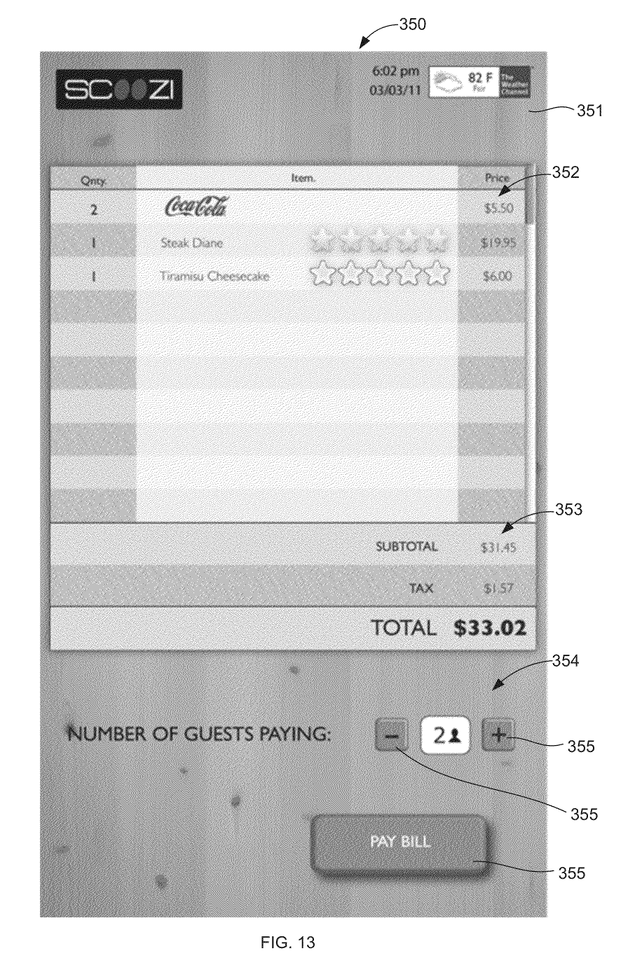

The menu category field 342 includes an array of buttons 343. In this manner, each button 343 can be associated with a specific item of a menu. For example, as shown in FIG. 12, a user can engage the “Drink” button 343 included in the menu category field 342 such that a drop down list 346 of drink items is displayed. Furthermore, the user can select a set of items from the drop down list 346 to add to an order. With the selection of the set of items, the items are configured to be displayed in the items ordered field 344. The items ordered field 344 is a list associated with the selected menu items. For example, as shown in FIG. 11, the items ordered field 344 can include a list of food items such as, “Classic Burger”. Additionally, the items ordered field can include a set of buttons 343 operative to increasing or decreasing the numbers of specific items to be ordered.

The items ordered field 344 also includes buttons 343 operative to displaying a drop down list 345 configured to customize an item. For example, as shown in FIG. 12, a user can engage the button 343 to display the drop down list 345 under the item “Classic Burger”. In this manner, the user can further select the way the “Classic Burger” is cooked (e.g., “Well Done”, “Medium Well”, “Medium”, “Medium Rare”, or “Rare”. In some embodiments, the drop down list 345 can include any suitable list of options associated with a specific item. In some embodiments, the drop list can include a portion configured to receive a user input such as typing. For example, in some embodiments, a user can insert the phrase “No Ice” in the drop down list 345 of a drink order. (Explanation that this functionality can be extended to a retail-like environment as well, such as the selection of an item of the same type but different color, etc.)

The items ordered field 344 also includes a button 343 operative to send a signal representing a confirmed order. For example, the items ordered field 344 can include the button 343 labeled “Order”. When selected, a signal can be sent to the processor representing a list generated from the items ordered field 344 (e.g., as generated by the menu module 119 described above with respect to FIG. 2). The processor can send a signal to the memory such that the list is stored in the memory and can be accessed by the host device H (FIG. 1). In some embodiments, the processor can send a signal representing the list to the host device H via the network N (FIG. 1).

FIGS. 13-23 are screenshots that illustrate a payment user interface 350. For example, the user (e.g., a patron and/or waitperson) can engage the tablet such that the payment interface 350 is shown on the display. As shown in FIG. 13, the payment interface 350 can include a header 351, an itemized field 352, a total field 353, and a split payment field 354. The header 351 included in the payment interface 350 can be any suitable shape, size, or configuration. In some embodiments, the header 351 can include a set of information, such as, for example, time, date, temperature, and/or login information. For example, as shown in FIG. 13, the header 351 includes the time, the date, and the temperature.

The itemized field 352 can include an itemized list of the menu items ordered and the cost associated with the item. Additionally, the itemized field 352 includes a portion configured to be engaged by the user to rate a specific menu item. For example, as shown in FIG. 13, the item “Tiramisu Cheesecake” can be rated as 5-stars (e.g., the user could select the rating scale such that all five stars become shaded). The total field 353 includes a portion configured to display a subtotal, a portion to display a sales tax, and a portion to display a total. In this manner, the total field 353 is configured to display a summation of all of the itemized costs included in the itemized field 352. The split payment field 354 can include buttons 355 operative to increase or decrease the number representative of the number of patrons to pay a bill (e.g., the number of patrons the bill will be split between). When the itemized field 352 and the total field reviewed and the correct number of patrons displayed in the split payment field 354, a user can engage the button 355 labeled “Pay Bill”.

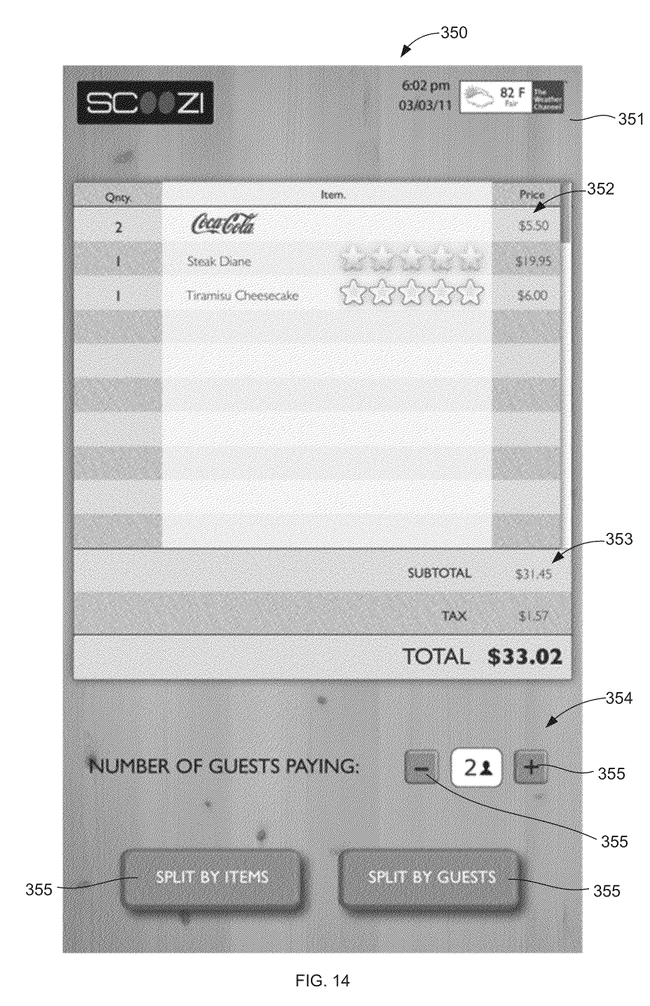

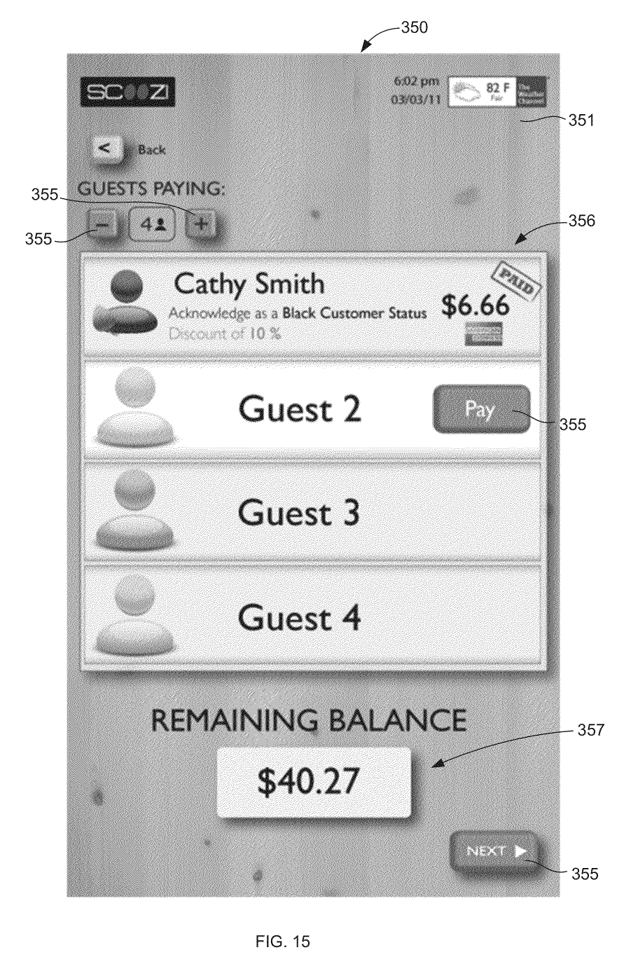

With the button 355 labeled “Pay Bill” engaged by the user, the split payment field 354 can be configured to display the buttons 355 labeled “Split By Items” and “Split By Guests”, as shown in FIG. 14. In this manner, the user (e.g., the patron or the waitperson) can select the method of splitting the check between any number of patrons. For example, FIG. 15 shows the payment interface 350 after the user engages the “Split By Guests” button 355. In this configuration, the payment interface 350 can include the header 351 configured to display the number of guests selected to split the check among. Additionally, the payment interface 350 is configured to display a guest field 356 and a balance field 357. The guest field 356 can include a list of the guests (e.g., patrons) to split the check among. In some embodiments, a guest can be associated with a user profile stored in the user profile database stored in the memory and/or a cloud server. The guest field 356 can display the user name associated with the user profile, a user picture, and any discounts the user is eligible for. For example, as shown in FIG. 15, the user “Cathy Smith” is eligible for a “Discount of 10%”. Furthermore, the guest field 356 can display an indication of which guest has paid a portion of the check. The balance field 357 can be configured to display the remaining portion of the check yet to be paid.

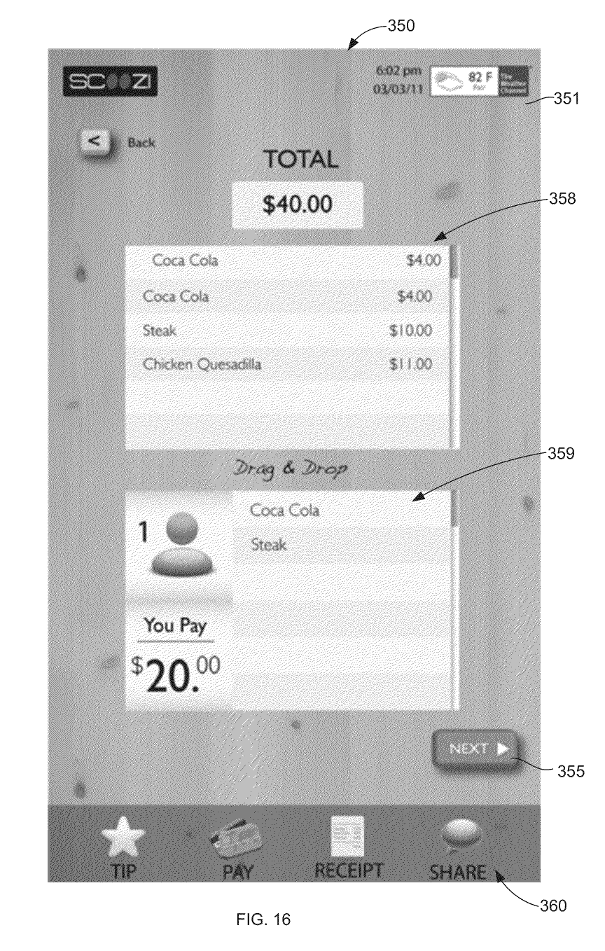

FIG. 16 shows the payment interface 350 after the user engages the “Split By Items” button 355. In this configuration, the payment interface 350 includes the header 351, an item list field 358, a selection field 359, and an action banner 360. The action banner 360 can include any number of graphics operative to perform a task. For example, the action banner 360 includes a receipt graphic that can be engaged by the user (such that the tablet displays the receipt interface 380). Similarly, any graphic included in the action banner 360 can be engaged such that the tablet displays a user interface associated with the action.

The item list field 358 can be configured to display a list representative of the menu items ordered. In this manner, the user can engage the items included in the item list field 358 associated with a specific guest and drag and drop (e.g., press the touch screen at the portion representing the item and/or, while pressing on the touch screen, drag the item to a second portion of the touch screen) the items into the selection field 359. With the items placed in the selection field 359, the selection field 359 can be configured to calculate a total based on the items displayed. Furthermore, with the desired items displayed in the selection field 359 the user can engage the button 355 labeled “Next”.

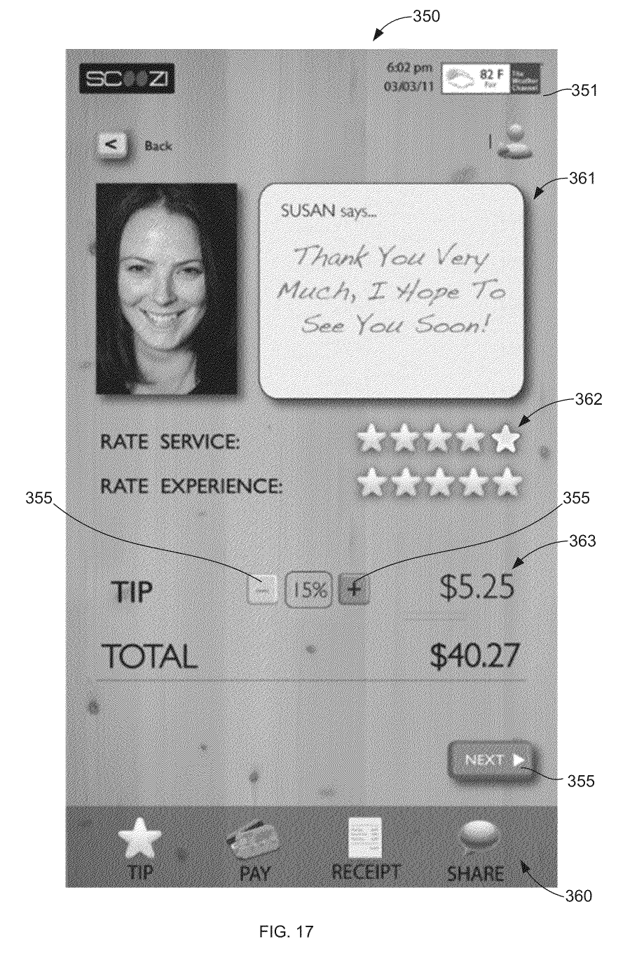

FIG. 17 shows the payment interface 350 after the user engages the “Next” button 355. In this configuration, the payment interface 350 includes the header 351, a profile field 361, a rating field 362, a tip field 363, and the action banner 360. The profile field 361 can include a profile picture of a waitperson that provided service to the guest and/or a logo of the merchant. Additionally, the profile field 361 can include a personal message from the waitperson. For example, as shown in FIG. 17, the profile field 361 includes a portion the states, “Thank you very much, I hope to see you soon!” In some embodiments, the profile field 361 can display a profile picture or a merchant's logo only. Conversely, in some embodiments, the profile field 361 can display a statement portion only.

The rating field 362 can be configured to display a rating scale. The guest can engage the rating scale to graphically represent the level of service and/or experience at the restaurant. For example, a guest can highly enjoy the experience at the restaurant and rate the experience with five stars. In some embodiments, a guest may receive poor service and rate the service with only two stars. Similarly stated, ratings including more stars equate to a better experience. The tip field 363 includes buttons 355 operative to increase or decrease a number representative of the percentage of tip to provide to the waitperson. For example, as shown in FIG. 17, a guest can engage the tip field 363 to add a “15%” tip to the total. The tip field 363 is further configured to add the tip amount to the total balance of the check. With the desired amount of tip displayed, the guest can engage the button 355 labeled “Next”.

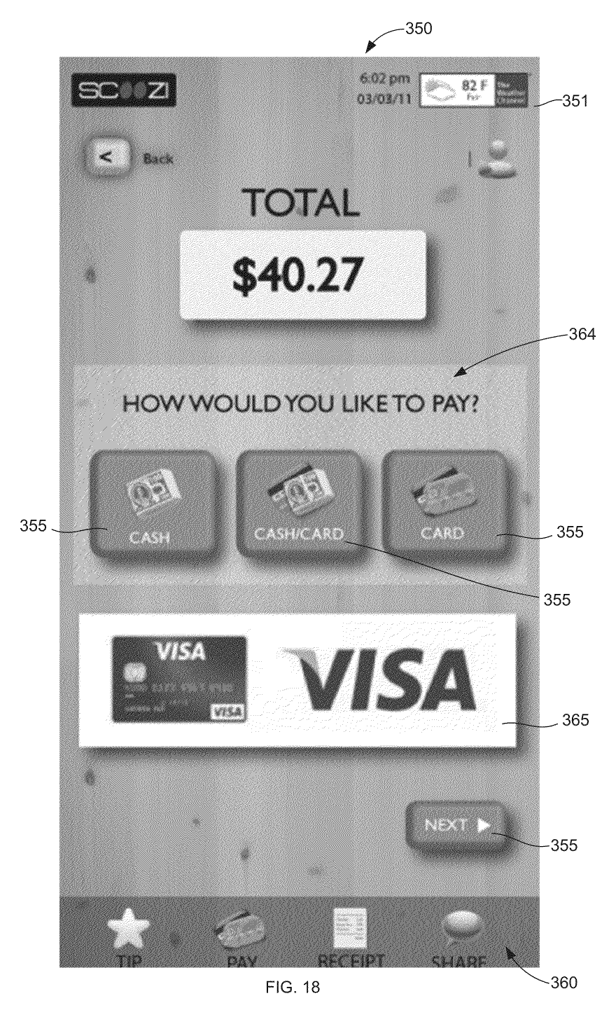

FIG. 18 shows the payment interface 350 after the user engages the “Next” button 355. In this configuration, the payment interface 350 includes the header 351, a payment field 364, an advertisement field 365, and the action banner 360. The advertisement field 365 can include any suitable advertisement. For example, the advertisement field 365 can include an advertisement for a credit card such as VISA. In some embodiments, the advertisement field 365 can include ads presented by partners of the establishment.

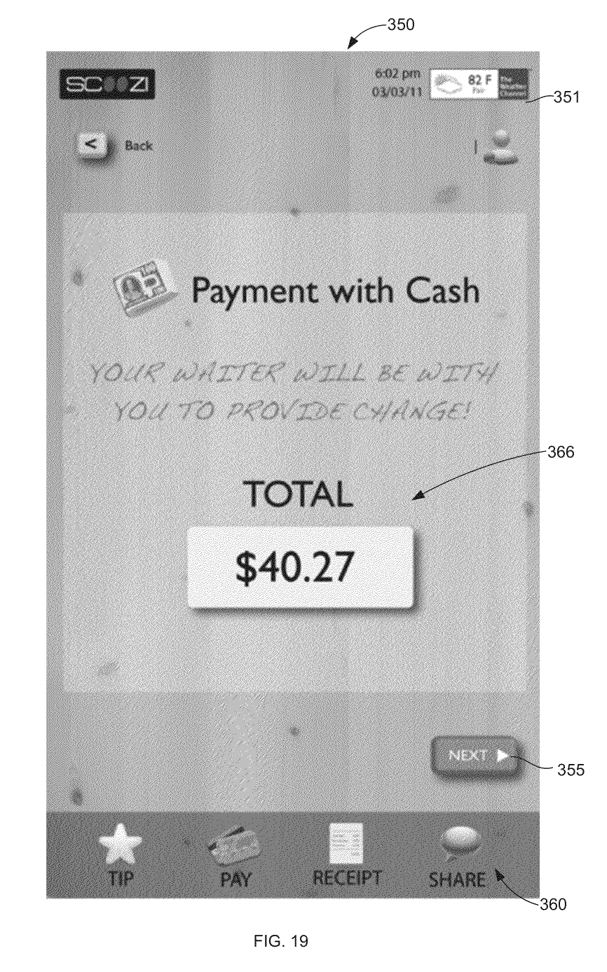

The payment field 364 can include buttons 355 operative to select the method of payment. For example, as shown in FIG. 18, the payment field 364 includes buttons 355 labeled, “Cash”, “Cash/Card”, and “Card”. In this manner, the guest can engage the button 355 associated with the type of payment the guest prefers. For example, FIG. 19 shows the payment interface 350 after the user engages the button 355 labeled “Cash”. The payment interface 350 includes a cash payment field 366 configured to display a message associated with acknowledging the selection. For example, in some embodiments, the cash payment field 366 can display a message that states, “Your waiter will be with you to provide change!”

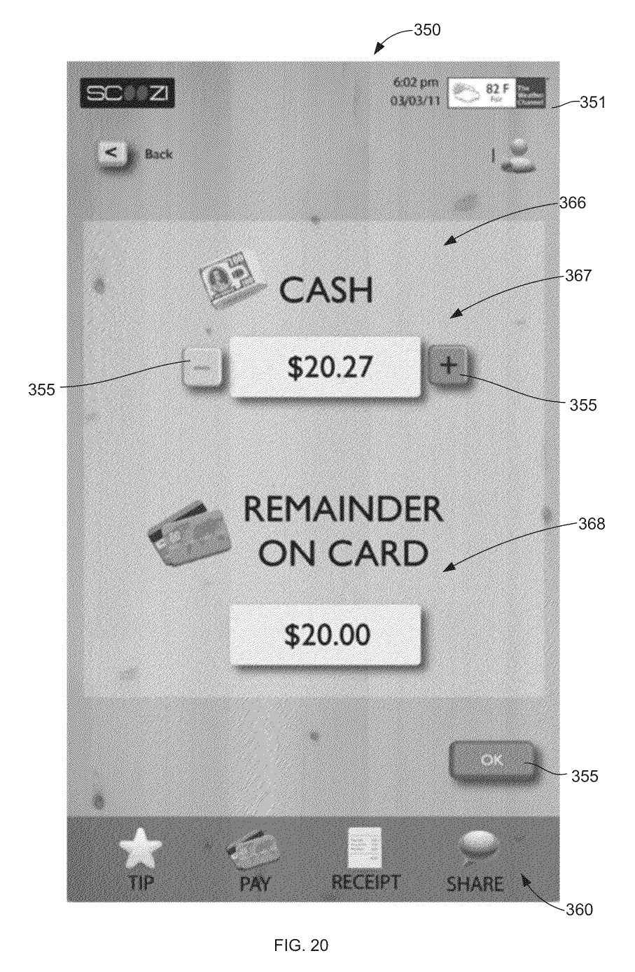

In some embodiments, the user engages the button 355 labeled “Cash/Card”. In this manner, the payment interface 350 is configured to display a split payment field 366. The split payment field 366 can include a cash portion field 367 and a card portion field 368. The cash portion field 367 can include buttons 355 operative to increasing or decreasing the portion of the check to be paid in cash. For example, as shown in FIG. 20, the cash portion field can display “$20.27”. The card portion field 368 can include a statement “Remainder on Card”. In this manner, the tablet (e.g., the processor) is configured to subtract the amount paid in cash from the total amount of the check. Therefore, the card portion field 367 displays the amount of the check to be charged to the card (e.g., “$20.00”). With the check split, the user can select the button 355 labeled “OK”, thereby confirming the split of the check.

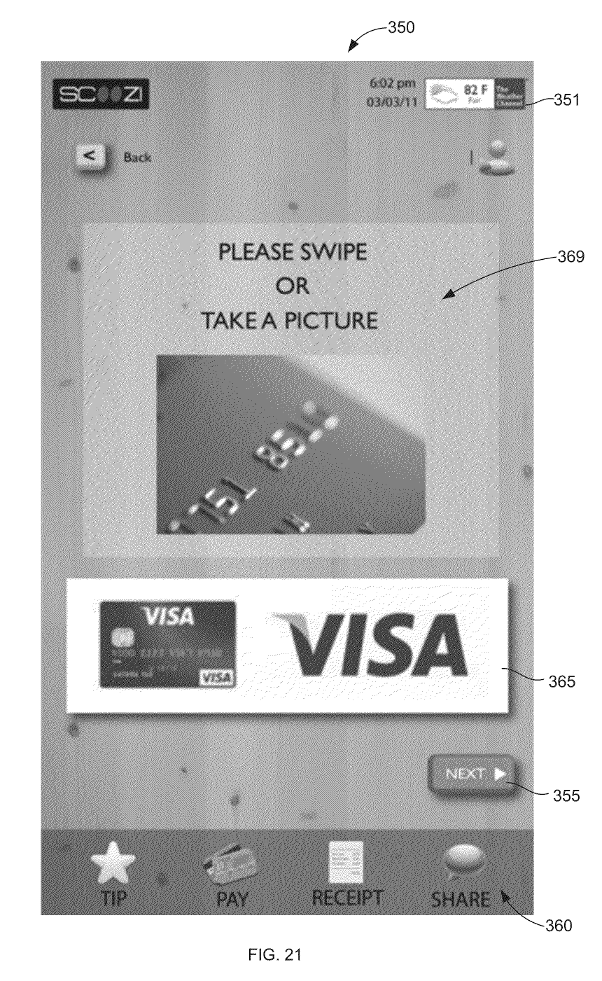

FIG. 21 shows the payment interface 350 after the user engaged the button 355 labeled “OK”. In this configuration, the payment interface 350 includes the header 351, a card payment field 369, the advertisement field 365, and the action banner 360. The card payment field 369 can include instructions associated with making a debit card or credit card payment. For example, as shown in FIG. 21, the card payment field 369 can state, “Please swipe or take a picture”. In this manner, the guest can engage the tablet to process a payment using a debit card or credit card. For example, in some embodiments, a guest can swipe a debit card through the magnetic strip reader 204 included in the tablet 200 described with respect to FIGS. 3-6. In some embodiments, a guest can make a payment by taking a picture of a credit or debit card. For example, in some embodiments, a guest can engage the tablet 200 such that the camera 208 takes a picture of a credit or debit card. The memory included in the tablet 200 can include instructions, executed by the processor, to send a signal representing payment information captured by the photo to a banking establishment, via the network N (e.g., the internet). In some embodiments, the tablet 200 can be configured to receive payment information via near field communication (NFC). In such embodiments, the processor and/or a module (e.g., an NFC module) can receive payment information from an electronic device via near field communication and be configured to send a signal, via the network N, to a bank for verification.

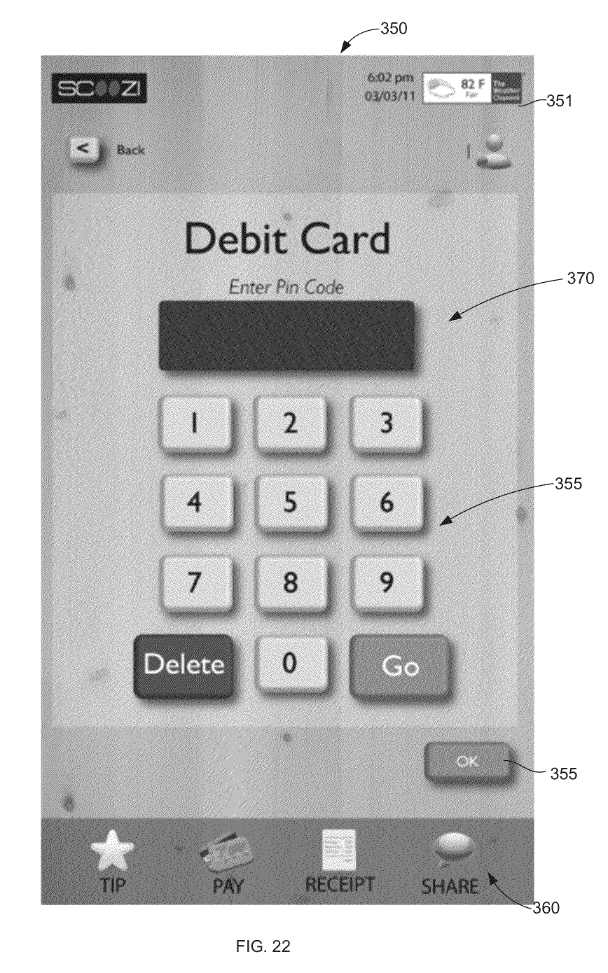

In some embodiments, the process (e.g., swiping, taking a picture, receiving a near field communication, and/or the like) of a debit card payment can trigger the payment interface 350 to display an interactive pin pad, as shown, for example, in FIG. 22. In this configuration, the payment interface 350 includes the header 351, a pin pad field 370, and the action banner 360. The pin pad field 370 can display a graphical representation of a pin pad such that a guest can engage buttons 355 representing numeric values to input a personal identification number (PIN) associated with the debit card. With the PIN entered, the guest can engage the button 355 labeled “Go”. In this manner, the tablet can process and/or verify the PIN information. In some embodiments, the pin pad field 370 can be configured to process PIN information after detecting a number of inputs (e.g., for numerical inputs). In some embodiments, the guest can engage the button 355 labeled “Ok” to process the PIN information.

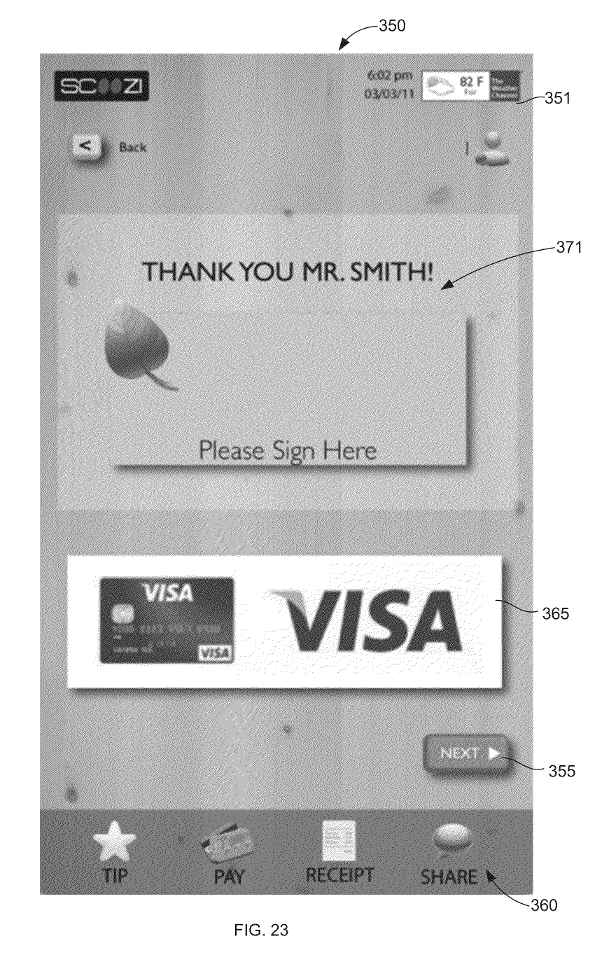

In some embodiments, the process (e.g., swiping, taking a picture, receiving a near field communication, and or the like) of a credit card payment can trigger the payment interface 350 to display an interactive signature pad, as shown, for example, in FIG. 23. In this configuration, the payment interface 350 includes the header 351, a signature field 371, the advertisement field 365, and the action banner 360. The signature field 371 can display a graphical representation of a signature portion included in a known paper receipt. A guest can engage (e.g., sign their name) the signature field 371 to verify the credit card payment. With the guest signature in the signature field 371, the guest can engage the button 355 labeled “Next” to process the credit card payment.

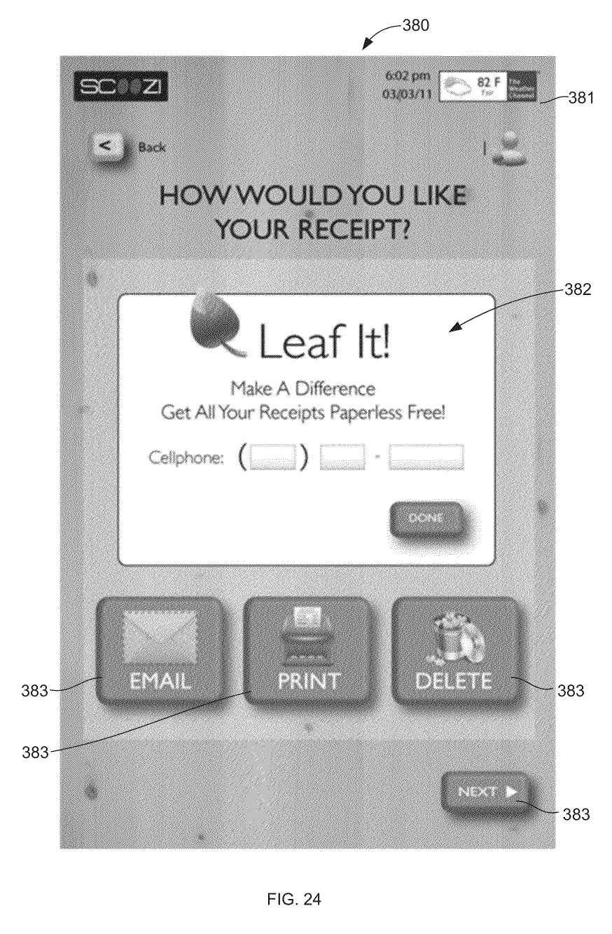

FIG. 24 illustrates a receipt interface 380 including a header 381 and a membership field 382. The header 381 included in the payment interface 380 can be any suitable shape, size, or configuration. In some embodiments, the header 381 can include a set of information, such as, for example, time, date, temperature, and/or login information. For example, as shown in FIG. 24, the header 381 includes the time, the date, and the temperature. The membership field 382 can display a message encouraging a guest to receive their receipt via email or to a mobile device application and/or the like. In this manner, the electronic check presenter system can reduce the environmental impact of the establishment by reducing the paper usage. Furthermore, the membership field 382 includes an input portion such that a guest can input their phone number to become a member of a loyalty program, mobile device application and/or the like so that the user can receive information from the establishment and/or partners of the establishment.

As shown in FIG. 24, the receipt interface 380 further includes buttons 383 operative to send an email including the receipt of payment, send an electronic receipt to a mobile device or internet application, to print the receipt, and/or to discard the receipt (e.g., delete from the memory). The guest can engage the button 383 associated with the manner in which the guest prefers to receive the receipt. For example, the guest can engage the button 383 labeled “Email” to receive the receipt via email. In some embodiments, the guest can engage the button 383 labeled “Next” to process the request for the receipt.

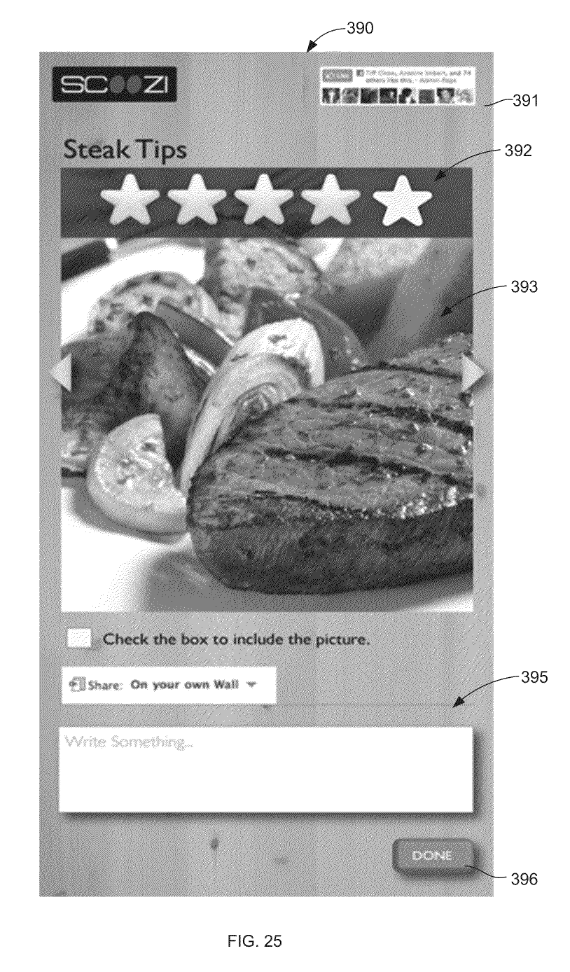

FIG. 25 illustrates a social networking interface 390 including a header 391, a rating field 392, a picture field 393, and a comment field 394. The header 391 included in the social networking interface 390 can be any suitable shape, size, or configuration. In some embodiments, the header 391 can include a set of information, such as, for example, profile information of guests that have shared their experience at the restaurant on a social networking site. For example, the header 391 can include thumbnail profile pictures of a set of guests that have shared their experience at the restaurant on Facebook ®.

The rating field 392 can include a rating portion configured to be engaged by the user to rate a specific menu item. For example, as shown in FIG. 25, the item “Steak Tips” can be rated as 4-stars (e.g., the user could select the rating scale such that four out of five stars become shaded). Similarly stated, the guest can engage the rating scale to graphically represent the level of quality of a menu item wherein ratings including more stars equate to a better quality.

The picture field 393 can include a picture to be shared on a social networking site. In some embodiments, the picture can relate to a guest ordered menu item. For example, in some embodiments, the picture can relate to the specific menu item associated with the rating portion (e.g., “Steak Tips”). In such embodiments, the rating field 392 can be dependent on the picture field 393. For example, in some embodiments, the picture field 393 can be configured to populate pictures associated with the guest selected menu items. The guest can scroll (e.g., engage arrowed shaped buttons 396 or swipe a finger) through the pictures and select the specific menu item to share and/or rate. In this manner, the rating field 392 can be configured to display a name of the specific menu item associated with the picture in the picture field 393. For example, as shown in FIG. 25, the rating field 392 displays “Steak Tips” and the picture field 393 displays a picture of steak tips.

In some embodiments, the picture field 393 can include a photo of a guest or guests. For example, in some embodiments, a user (e.g., a guest or a waitperson) can engage the tablet (e.g., the tablet 200 shown with respect to FIGS. 3-6) to take a picture of a guest or guests. In such embodiments, the guest can select the picture from the picture field 393 and engage the comment field 394 to share the picture on, for example, Facebook ®.

The comment field 394 can include a comment portion configured display a user input. For example, the social network interface 390 can display a keyboard interface (not shown) to be engaged by the guest. In this manner, the guest can input a comment in the comment portion and engage the button 396 labeled “Done” to post the comment and the picture included in the picture field 393 to, for example, Facebook ®. In some embodiments, the social network interface 390 can be configured to share a picture, a rating, and/or a comment on any suitable social networking site such as, for example, Twitter ®, Yelp ®, Google+ ®, Foursquare ®, and/or the like.

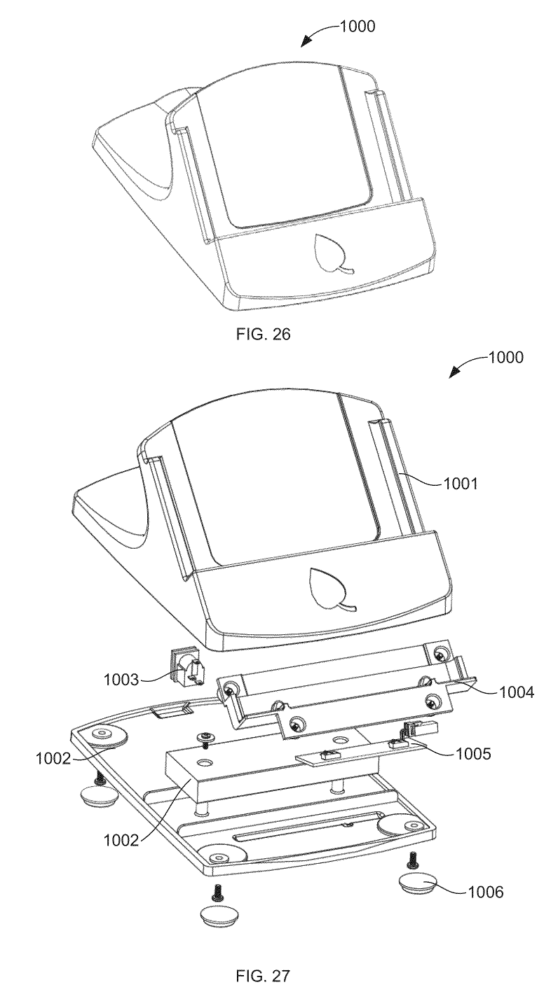

Referring now to FIGS. 26 and 27, a computerized bill presenter system can include a charging dock. A charging dock 1000 can be configured to charge a tablet (not shown) included in the computerized bill presenter system. The charging dock 1000 can include a housing 1001, a base 1002, and electrical socket 1003, a dock portion 1004, and a charge member 1005. The housing 1001 can be any suitable shape, size, or configuration. For example, as shown in FIG. 26, the housing 1001 can include an angular portion configured to receive at least a portion of the tablet (e.g., the tablet 200 of FIGS. 3-6). Furthermore, housing 1001 can be coupled the base 1002 to house at least a portion of the electrical socket 1003 and the charge member 1005, as shown in FIG. 27.

The base 1002 can be coupled to the housing 1001 in any suitable manner. For example, as shown in FIG. 27, the base 1002 can be coupled to the housing 1001 via a set of screws and mounting apertures. The base 1002 can be configured to include a set of pads 1006 disposed on a bottom surface of the base 1002. The pads 1006 can be formed from any suitable material, such as, for example, a rubber. Additionally, the pads 1006 can define a frictional contact with a surface on which the charging dock 1000 is placed, thereby, reducing the likelihood of the charging dock 1000 sliding on the surface.

The electrical socket 1003 can be operably coupled to an electrical source (e.g., an 110V electrical outlet) to receive a flow of current. In some embodiments, the charging dock 1000 can include an electrical plug and/or electrical wire configured to couple the electrical socket 1003 to the electrical source. The electrical socket 1003 can be any suitable socket configured to receive a plug, a wire, and/or any other suitable connection. In this manner, the electrical socket 1003 can function similarly to know electrical sockets or connections to provide a flow of current to the electrical components included in the charging dock 1000.

The housing 1001 can also couple to the dock portion 1004. The dock portion 1004 can be configured to receive at least a portion of the tablet, such that the tablet is removably coupled to the charging dock 1000. Furthermore, the dock portion 1004 can be coupled to the charge member 1005. In this manner, when the tablet is in contact with the dock portion 1004, the charge member 1005 can transfer a portion of a flow of current to the tablet, thereby charging a battery included in the tablet. As described above, in some embodiments, the charge member 1005 can electrically engage the tablet via a plug, a socket, a contact or contacts, or via induction.

The housing 1001 can further be configured to house a counterweight 1007. The counterweight 1007 can be coupled to the base 1002 via screws, as shown in FIG. 27. In some embodiments, the counterweight 1007 can act to stabilize the charging dock 1000. For example, with the tablet in contact with the dock portion 1004, the counterweight 1007 can act to lower a center of gravity, collectively defined by the tablet and the charging dock 1000, thereby stabilizing the charging dock 1000 and the tablet.

While not shown in FIGS. 26 and 27, the charging dock 1000 can include any suitable electrical components operative to the functioning of the charging dock 1000. For example, the charging dock 1000 can include a set of wires configured to electrically couple the electrical socket 1003 to the charge member 1005. In some embodiments, the electrical socket 1003 and/or the charge member 1005 can include plugs or pins configured to couple to an electrical wire and/or connector.

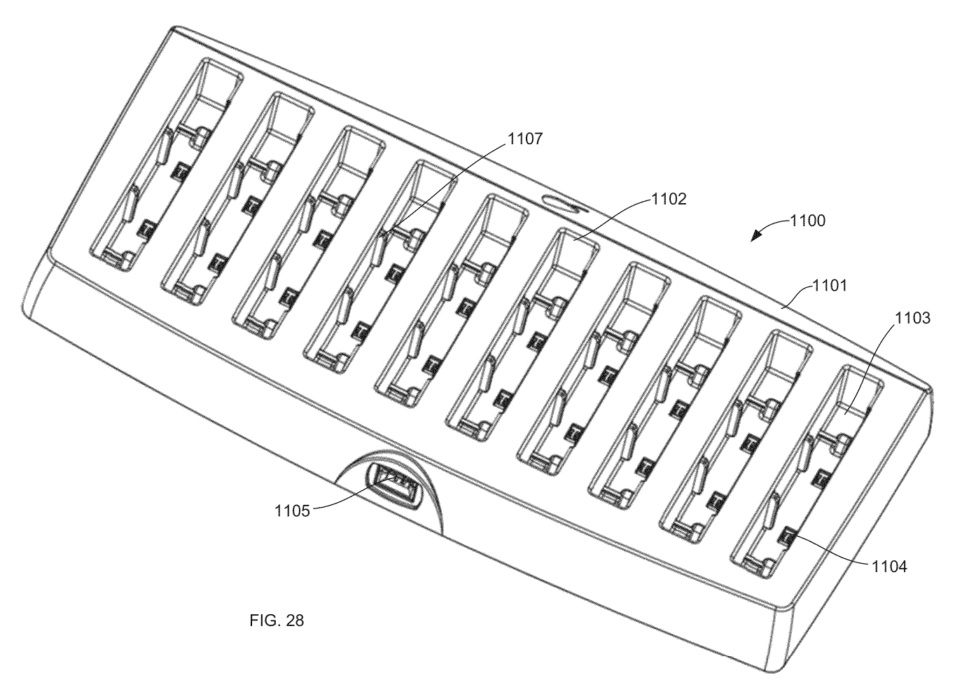

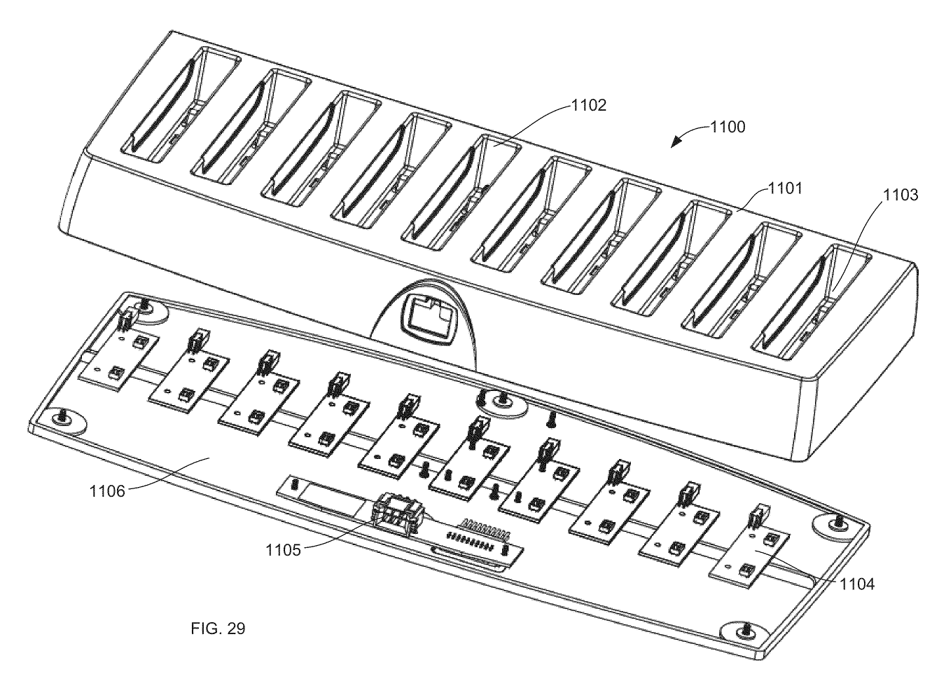

Referring to FIGS. 28 and 29, in some embodiments, a computerized bill presenter system can include a charging station. A charging station 1100 can be configured to charge a tablet or tablets (not shown) included in the computerized bill presenter system. The charging station 1100 can include a housing 1101, a base 1106, and electrical socket 1105, and a set of charge members 1104. The housing 1101 can be any suitable shape, size, or configuration. For example, as shown in FIG. 28, the housing 1101 can be substantially rectangular. The housing 1101 can include an outer surface 1102 configured to define a set of recesses 1103. The recesses 1103 are configured to receive at least a portion of the tablet or tablets included in the computerized bill presenter system (e.g., one or more tablets can be docked in the charging station 1100 at one time). In some embodiments, the charging station 1100 can be configured to receive up to 10 tablets. In some embodiments, the charging station 1100 can include a wireless router or a wireless access point configured to establish wireless communication between a plurality of tablets and a local area network.

The housing 1101 can further include a set of tabs 1107 movably disposed within the recesses 1103 defined by the outer surface 1102. The tabs 1107 can be configured to move in a direction normal to the direction of insertion of the tablets. Expanding further, as the tablet (not shown) is moved in a downward direction and inserted into the recess 1103, the tablet can engage the tabs 1107, such that the tablet moves the tabs 1107 normal to the downward direction the tablet is moving. The tabs 1107 can be operatively coupled to a set of springs configured to exert a reaction force in response to the motion of the tabs 1107. This arrangement allows the tabs 1107 to engage the tablets with a given amount of pressure such as to stabilize the tablet within the recess 1103.

As shown in FIG. 29, the base 1106 can be coupled to the housing 1101 via a set of screws. Furthermore, the base 1106 and the housing 1101 collectively house at least a portion of the charge member 1104 and the electrical socket 1105. In some embodiments, the base 1106 can include a set of pads (not shown) disposed on a bottom surface of the base 1106. The pads can be substantially similar in form and function to the pads 1006 included in the charging dock 1000.

The electrical socket 1105 can be coupled to an electrical source (e.g., an 110V electrical outlet) to receive a flow of current. In some embodiments, the charging station 1100 can include an electrical plug and/or electrical wire configured to couple the electrical socket 1105 to the electrical source. The electrical socket 1105 can be any suitable socket configured to receive a plug, a wire, and/or any other suitable connection. In this manner, the electrical socket 1105 can function similarly to know electrical sockets or connections to provide a flow of current to the electrical components included in the charging station 1100.

The base 1106 can further couple to the set of charge members 1104. The charge members 1104 can transfer a portion of a flow of current to the tablet or tablets, such that a battery included in the tablets receives an electrical charge. As described above, in some embodiments, the charge members 1104 can electrically engage a tablet via a plug, a socket, a contact or contacts, or via induction.

While not shown in FIGS. 28 and 29, the charging station 1100 can include any suitable electrical components operative to the functioning of the charging station 1100. For example, the charging station 1100 can include a set of wires configured to electrically couple the electrical socket 1105 to the charge members 1104. In some embodiments, the electrical socket 1105 and/or the charge members 1104 can include plugs or pins configured to couple to an electrical wire and/or connector.

Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

While various embodiments have been described above, it should be understood that they have been presented by way of example only, and not limitation, and as such, various changes in form and/or detail may be made. For example, while shown in FIG. 4 as being disposed on the side of the tablet 200, the magnetic strip reader 204 can be disposed at any given location on the tablet 200. Any portion of the apparatus and/or methods described herein may be combined in any suitable combination, unless explicitly expressed otherwise. For example, while not shown in FIGS. 26-29 the charging dock 1000 and the charging station 1100 can include a status indicator light, as described with respect to FIGS. 3-6. In this manner, the status indicator light could be configured to indicate a charge level of one or more tablets. For example, the status indicator light can display a red light when the tablet is not fully charged and a green light when the tablet becomes fully charged.

Where methods and/or schematics described above indicate certain events and/or flow patterns occurring in certain order, the ordering of certain events and/or flow patterns may be modified. Additionally certain events may be performed concurrently in parallel processes when possible, as well as performed sequentially.

We claim:

1. An apparatus, comprising:
a touch screen configured to display information and configured to receive input associated with payment of a bill;
a payment processor configured to receive and process payment information;
a lighting module configured to output visual indicia associated with a step of a bill payment process; and
a wireless communication device configured to send and receive data associated with a financial transaction.

2. The apparatus of claim 1, wherein the payment processor includes a magnetic strip reader.

3. The apparatus of claim 2, wherein the lighting module is configured to provide a prompt for the user to swipe at least one of a credit card, a debit card and a gift card.

4. The apparatus of claim 1, wherein the payment processor includes a near field communication (NFC) module.

5. The apparatus of claim 4, wherein the lighting module is configured to provide a prompt for the user to position an NFC enabled device within range of the NFC module.

6. The apparatus of claim 1, wherein the payment processor includes a photo card capture module.

7. The apparatus of claim 6, wherein the lighting module is configured to provide a prompt for the user to take a picture of at least one of a credit card, a debit card and a gift card.

8. The apparatus of claim 1, wherein the lighting module includes an indicator light, the indicator light configured to display a visual indication of a status of at least one of the computerized bill presenter and the bill payment process.

9. A system, comprising:
a computerized bill presenter configured to process payment of a bill, the computerized bill presenter including:
a touch screen configured to display information and configured to receive input associated with payment of the bill;
a payment processor configured to receive payment information and generate an electronic receipt;
a wireless communication device configured to send and receive data associated with the payment of the bill, the wireless communication device further configured to receive rating information and facilitate the posting of the rating information on a social networking site.

10. The system of claim 9, wherein the rating information includes at least one of a picture, a comment, a numerical rating or a icon associated with a rating.

11. The system of claim 9, further comprising a lighting module having an indicator light configured to display a visual indication of a status of at least one of the computerized bill presenter or the bill payment process.

12. The system of claim 11, wherein the lighting module is configured to provide a visual indication associated with at least one of a status of a bill payment process.

13. The system of claim 12, wherein the status is associated with at least one of acceptance of a payment, processing of a payment or rejection of a payment.

14. A system, comprising:
a plurality of electronic invoice presenters, each of the electronic invoice presenters including:
a touch screen configured to display information and configured to receive input associated with payment of a bill;
a payment processor configured to receive and process payment information;
a wireless communication device configured to send and receive data associated with a financial transaction;
a charging station configured to mate with and charge the plurality of electronic invoice presenters.

15. The system of claim 14, wherein the charging station includes electrical contacts for electrically coupling the charging station to each of the plurality of electronic invoice presenters.

16. The system of claim 14, wherein the charging station charges the plurality of electronic invoice presenters via induction.

17. The system of claim 14, wherein the charging station includes a wireless router for establishing communication between each of the plurality of electronic invoice presenters and a central computing system.
